(19) United States
(12) Patent Application Publication
(10) Pub. No.: US 2007/0061402 A1
(43) Pub. Date: Mar. 15, 2007

(54) Multipurpose internet mail extension (MIME) analysis

(75) Inventors: John D. Mehr, Seattle, WA (US); Nathan D. Howell, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/228,032

(22) Filed: Sep. 15, 2005

(51) Int. Cl. G06F 15/16

(52) U.S. Cl. 709/206

(57) ABSTRACT

Techniques that are employable to perform multipurpose internet mail extension (MIME) analysis are presented herein.

### BACKGROUND

Email provides an efficient communication technique in which a message may be sent over great distances quickly and at a minimal cost to a sender of the message. Accordingly, the prevalence of email is ever increasing such that a user may interact with tens and hundreds of emails in a given day which relate a variety of uses, such as personal, business, billing, and so on. However, malicious uses of email also continue to increase due to this efficiency.

One such example is unsolicited commercial email (UCE) messages, otherwise know as “spam”. Spam is typically thought of as an email that is sent to a large number of recipients, such as to promote a product or service. Because sending an email generally costs the sender little or nothing to send, “spammers” have developed which send the equivalent of junk mail to as many users as can be located. Even though a minute fraction of the recipients may actually desire the described product or service, this minute fraction may be enough to offset the minimal costs in sending the spam due to the efficiencies available to communicate email. Consequently, spammers are responsible for communicating a vast number of unwanted and irrelevant emails to a large number of users. Thus, a typical user may receive a large number of these irrelevant emails, thereby hindering the user's interaction with relevant emails. In some instances, for example, the user may be required to spend a significant amount of time interacting with each of the unwanted emails in order to determine which, if any, of the emails received by the user might actually be of interest.

Further, the amount of spam may result in increased costs to communication services that communicate the spam. For example, as the number of messages, and especially spam, continues to increase, so to does the amount of resources needed to analyze the messages. This increase in resources may consume significant resources which otherwise could be used for legitimate purposes, such as the transfer of the emails themselves. Thus, spam may reduce the overall efficiency of email communication as a whole, thereby even affecting users who do not receive the spam message. For instance, email messages communicated to a large number of users of a communication system may reduce the resources available to communicate messages to other users of the communication system.

### SUMMARY

Techniques are described which are employable to analyze a multipurpose internet mail extension (MIME) structure of email. This analysis may provide a wide variety of functionality. For example, a plurality of email may be analyzed to determine a MIME structure of each email. Each determined MIME structure may be represented as a virtual tree having individual features, each of which may be expressed as a tupled expression and arranged to indicate an order, in which, the individual features of the respective email are arranged. The tupled expressions may thus represent content types of the email and therefore provide a generalization of content and arrangement of content in each of the email. These generalizations may then be utilized to create filters based on arrangements and expressions which indicate an increased or decreased likelihood of being spam. For example, a particular arrangement of media types in a MIME structure of an email may indicate an increased likelihood of the email being spam. Therefore, a filter may be created which addresses this increased likelihood when confronted with an email having the particular arrangement, such as to adjust a score to indicated an increased likelihood that the email is spam.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment operable for communication of email across a network.

FIG. 2 is an illustration of an exemplary implementation of a system which shows a client and a communication service of FIG. 1 in greater detail.

FIG. 3 is a flow diagram depicting a procedure in an exemplary implementation in which structural expressions obtained through analysis of email structures are utilized in the creation of filters to process email.

FIG. 4 is a flow diagram depicting a procedure in an exemplary implementation in which a score is computed indicating a relative likelihood that an email is spam based at least in part on a MIME structure of the email.

The same reference numbers are utilized in instances in the discussion to reference like structures and components.

### DETAILED DESCRIPTION

Overview

Unsolicited commercial email (UCE) messages, otherwise know as “spam”, may inconvenience recipients of the messages as well as communication systems utilized to communicate the messages. This inconvenience may result in significant amounts of lost time to recipients of the messages and costs to the communication systems which communicate the messages. Accordingly, techniques are described, in which, a structure of an email may be utilized to help distinguish spam from “legitimate” email.

Email communicated by a communication service, for instance, may be examined to determine a Multipurpose Internet Mail Extension (MIME) structure for each of the emails. Structures, and media types included in the structures, may then be identified through the examination which are indicative of an increased likelihood that the email is “spam” sent by a “spammer”. These identified structures in this instance are used to configure a filter, such that, other emails having such a structure are considered to have a corresponding increased likelihood that the other emails are spam. Thus, the identified structure of subsequent emails may be employed to help determine relative likelihoods that the emails are spam or legitimate. For instance, this determination may be used in the calculation of a numerical score that is indicative of relative likelihoods that the email is spam or legitimate.

In the following discussion, an exemplary environment is first described which is operable to perform email analysis techniques, including analysis of an email structure. Exemplary procedures are then described which may be employed in the described exemplary environment, as well as in other environments.

Exemplary Environment

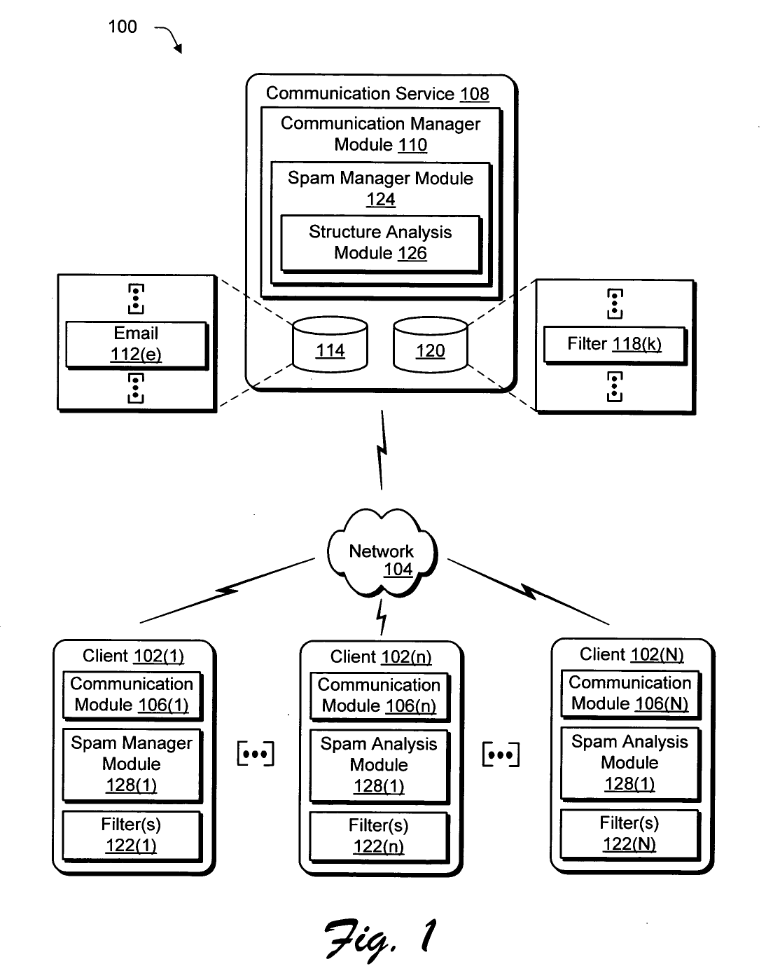

FIG. 1 illustrates an environment 100 operable to communicate email across a network. The environment 100 is illustrated as including a plurality of clients 102(1), . . . , 102(n), . . . , 102(N) that are communicatively coupled, one to another, over a network 104. The plurality of clients 102(1)-102(N) may be configured in a variety of ways. For example, one or more of the clients 102(1)-102(N) may be configured as a computer that is capable of communicating over the network 104, such as a desktop computer, a mobile station, a game console, an entertainment appliance, a set-top box communicatively coupled to a display device, a wireless phone, and so forth. Thus, the clients 102(1)-102(N) may range from full resource devices with substantial memory and processor resources (e.g., personal computers, television recorders equipped with hard disk) to low-resource devices with limited memory and/or processing resources (e.g., traditional set-top boxes). In the following discussion, the clients 102(1)-102(N) may also relate to a person and/or entity that operate the client. In other words, client 102(1)-102(N) may describe a logical client that includes a user, software and/or a machine.

Additionally, although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks. For instance, clients 102(1), 102(n) may be communicatively coupled via a peer-to-peer network to communicate, one to another. Each of the clients 102(1), 102(n) may also be communicatively coupled to client 102(N) over the Internet. In another instance, the clients 102(1), 102(n) are communicatively coupled via an intranet to communicate, one to another. Each of the clients 102(1), 102(n) in this other instance is also communicatively coupled via a gateway to access client 102(N) over the Internet. A variety of other instances are also contemplated.

Each of the plurality of clients 102(1)-102(N) is illustrated as including a respective one of a plurality of communication modules 106(1), . . . , 106(n), . . . , 106(N). In the illustrated implementation, each of the plurality of communication modules 106(1)-106(N) is executable on a respective one of the plurality of clients 102(1)-102(N) to send and receive email messages. Email employs standards and conventions for addressing and routing such that the email may be delivered across the network 104 utilizing a plurality of devices, such as routers, other computing devices (e.g., email servers, mail transfer agents (MTAs)), and so on. In this way, emails may be transferred within a company over an intranet, across the world using the Internet, and so on. An email, for instance, may include a header, text, and attachments, such as documents, computer-executable files, and so on. The header contains technical information about the source and oftentimes may describe the route the message took from a sender to a recipient.

In the illustrated implementation, the communication modules 106(1)-106(N) communicate with each other through use of a communication service 108. The communication service 108 is illustrated as including a communication manager module 110 (hereinafter “manager module”) which is executable thereon to route email between the clients 102(1)-102(N). For instance, client 102(1) may execute the communication module 106(1) to form an email for communication to client 102(n). The communication module 106(1) communicates the email to the communication service 108, which is then stored as one of the plurality of email 112(e) in storage 114. Client 102(n), to retrieve the email, “logs on” to the communication service 108 (e.g., by providing a user identification and password and/or through an authentication service) and retrieves emails from a respective user's account. In this way, a user may retrieve corresponding emails from one or more of the plurality of clients 102(1)-102(N) that are communicatively coupled to the communication service 108 over the network 104.

As previously described, the efficiently of the environment 100 has also resulted in communication of unwanted messages, commonly referred to as “spam”. Spam is typically provided via email that is sent to a large number of recipients, such as to promote a product or service. Thus, spam may be thought of as an electronic form of “junk” mail. Because a vast number of emails may be communicated through the environment 100 for little or no cost to the sender, a vast number of spammers are responsible for communicating a vast number of unwanted and irrelevant messages. Thus, each of the plurality of clients 102(1)-102(N) may receive a large number of these irrelevant messages, thereby hindering the client's interaction with actual emails of interest and consuming resources of the communication service 108.

One technique which may be utilized to hinder the communication of unwanted messages is through the use of “filters”, which are also referred to as “spam filters”. Spam filters may be utilized to process messages to filter unwanted “spam” email from “legitimate” email. In the illustrated environment 100, a plurality of filters 118(k) is illustrated as stored in storage 120 on the communication service 108 which may be utilized to filter email 112(e) communicated through the communication service 108. Likewise, the clients 102(1)-102(N) may also employ one or more respective filters 122(1)-122(N), which may be the same as or different from the filters 118(k) employed by the communication service 108.

The communication service 108, for instance, is illustrated as including a spam manager module 124 having a structure analysis module 126. The spam manager module 124 is representative of functionality that is configured to manage spam, which may include identifying spam from legitimate email (e.g., through use of the filters 118(k)) and performing one or more corresponding actions based on the identification. For example, the spam manager module 124 may route email having an increased likelihood of being spam differently (e.g., to a spam folder) than email which has a lower such likelihood, e.g., directly to an “inbox”. In another example, the spam manager module 124 selects additional filters 118(k) for further processing based on a result of an initial one or more of the filters 118(k). A variety of other examples are also contemplated.

The structure analysis module 126 is representative of functionality that may analyze the structure of email 118(k). This analysis may be utilized in a variety of ways, such as in the creation of one or more of the filters 118(k) that process email 112(e). For example, the structure analysis module 126 may analyze the Multipurpose Internet Mail Extension (MIME) components of email 112(e) to determine a MIME structure of the email. MIME provides a technique for registration of file types with information about modules (e.g., applications) which “understand” (i.e., may process) the file types. Thus, MIME provides for automatic recognition and rendering of file types that are registered using the MIME technique.

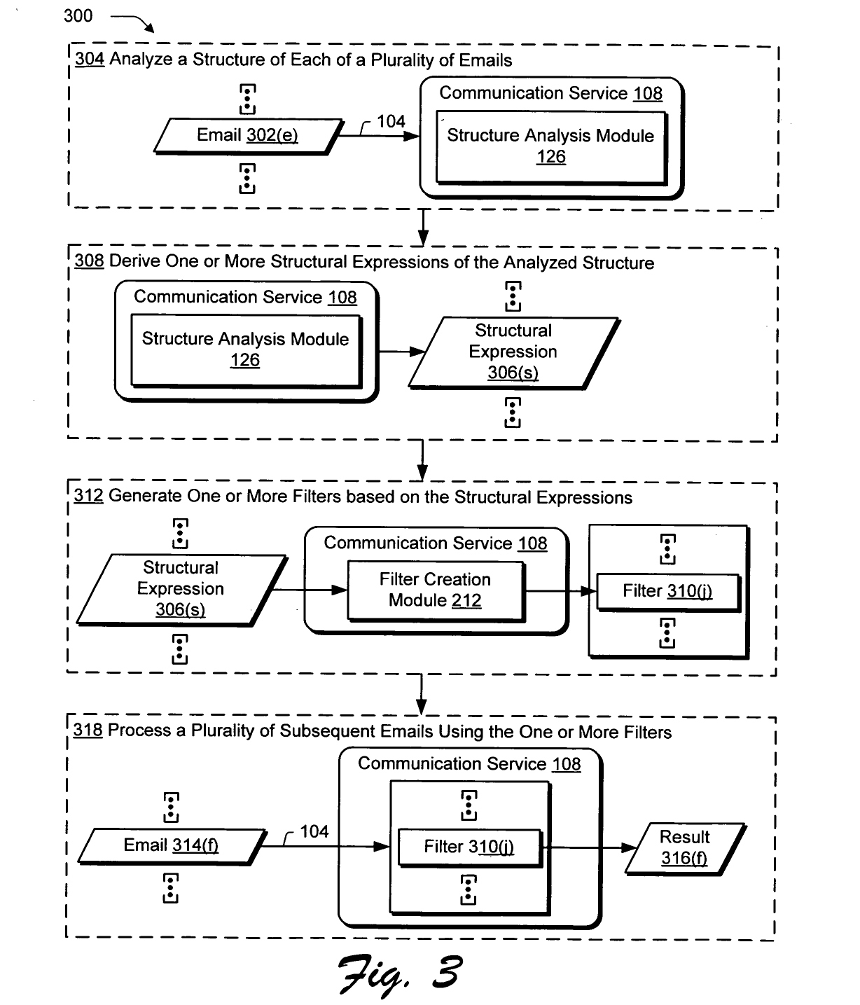

In the illustrated implementation, the MIME structure is indicative of whether an email message is legitimate or spam, and thus, may be utilized as one of a plurality of criteria employed by the filters 118(k) to process email. Further discussion of creation of filters utilizing MIME analysis and management of email based on such filters may be found beginning in relation to FIG. 3. It should be noted that although execution of the spam manager module 124 by the communication service 108 has been described, similar functionality may also be employed by the clients 102(1)-102(N) through execution of respective spam manager modules 128(1)-128(N).

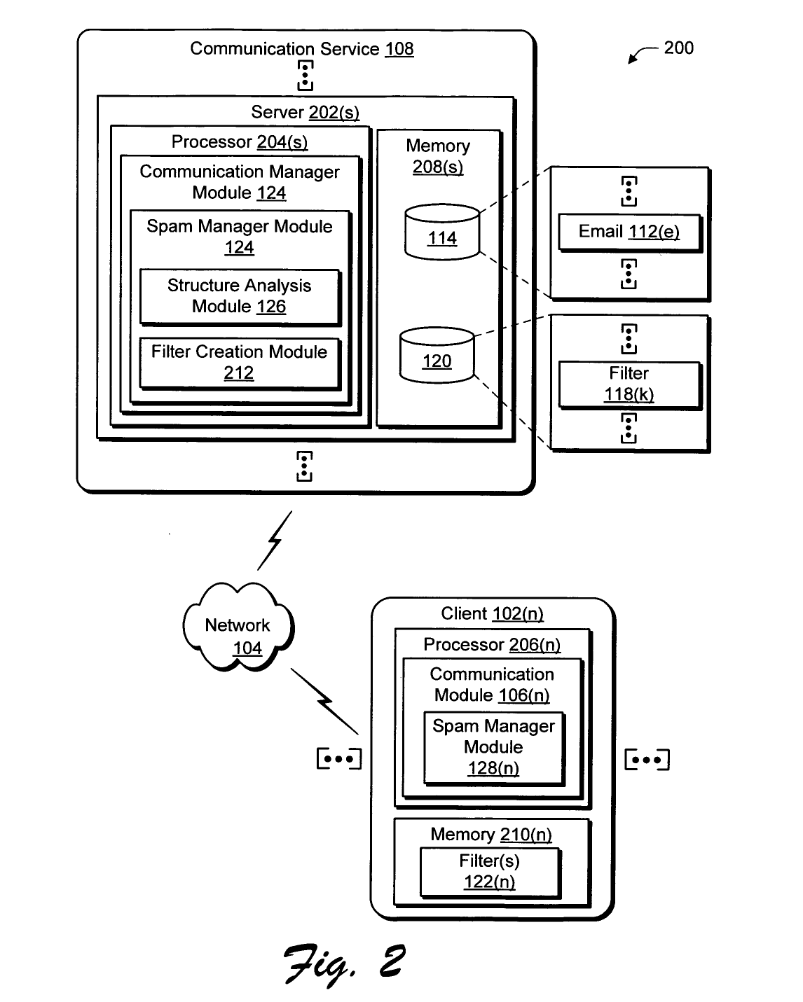

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the MIME structural strategies described below are platform-independent, meaning that the strategies may be implemented on a variety of commercial computing platforms having a variety of processors.

FIG. 2 illustrates an exemplary implementation of a system 200 showing the client 102(n) and the communication service 108 of FIG. 1 in greater detail. The communication service 108 is illustrated as being implemented by a plurality of servers 202(s) (where “s” can be any integer from one to “S”) and the client 102(n) is illustrated as a client device. Accordingly, the servers 202(s) and the clients 102(n) include respective processors 204(s), 206(n) and respective memories 208(s), 210(n).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 208(s), 210(n) is shown, respectively, for the servers 202(s) and the clients 102(n), a wide variety of types and combinations of memory may be employed, such as random access memory (RAM), hard disk memory, removable medium memory, and other types of computer-readable media.

The communication manager module 124 is illustrated as being executed on the processor 204(s), and is also storable in memory 208(s) of the server 202(s). The communication manager module 124 is representative of functionality that manages emails communicated through the communication service, such as to route emails to correct user accounts, scan email for viruses, authenticate client access to accounts, and so on. In the illustrated implementation, the spam manager module 124 is illustrated as within the communication manager module 124, which in this instance indicates that the functionality represented by the spam manager module 124 may be incorporated within the communication manager module 124. In another implementation, however, the functionality of the spam manager module 124 may be provided as one or more stand-alone modules without departing from the spirit and scope thereof.

The spam manager module 124 is further illustrated as having a structure analysis module 126 and a filter creation module 212. The structure analysis module 126 is representative of functionality that analyzes and represents structures of email messages. For instance, the structure analysis module 126 is executable build a virtual tree that represents the MIME structure of an email. In this way, the virtual tree provides an abstraction mechanism to represent content types of the email. This abstraction may then lead to enhanced differentiation between spam and legitimate (i.e., non-spam) email encountered by the communication system 108.

The output of the structure analysis module 126 (e.g., the virtual tree), for instance, may be provided to the filter creation module 212 to create and adjust filters 118(k) utilized to process email. For example, the filter creation module 212, when executed, may employ machine learning to identify structural differences found in spam which may be indicative of an increased likelihood that an email is spam and/or sent from a spammer. The identified structural differences may then be utilized to create a filter 118(k) for processing emails. For instance, the filters 118(k) may each be utilized to arrive at a score which is indicative of a relative likelihood that an email message is spam. The likelihood based on the structure (e.g., the MIME structure) may be employed with the other criteria to arrive at a score that indicates a relative likelihood that an email is spam. This score may then be utilized by the spam manager module 124 to perform one or more corresponding actions, such as to route the email to a spam folder as opposed to the client's 102(n) inbox.

Although analysis, creation and management was described as being performed by the communication service 108, this functionality may also be employed by one or more of the clients 102(1)-102(N). For example, the communication module 106(n) is illustrated as including a spam manager module 128(n), both of which are shown as being executed on the processor 206(n) and are storable in memory 210(n). The spam manager module 128(n), like the spam manager module 124 of the communication service 108, is executable to manage spam, such as to analyze structures and create filters 122(n) to distinguish spam from legitimate email. In another example, these actions may be performed by both the communication service 108 and the client 102(n). For example, the communication service 108 may create filters that are communicated to the client 102(n) for use in processing emails. A variety of other examples are also contemplated.

Exemplary Procedures

The following discussion describes email structural analysis and management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. It should also be noted that the following exemplary procedures may be implemented in a wide variety of other environments without departing from the spirit and scope thereof.

FIG. 3 depicts a procedure 300 in an exemplary implementation in which structural expressions obtained through analysis of email structures are utilized in the creation of filters to process email. A structure of each of a plurality of emails 302(e) is analyzed (block 304). For example, the communication service 108 may receive the plurality of emails 302(e) for communication between the clients 102(1)-102(N). To analyze the structure of the emails 302(e), the communication service 108 executes the structure analysis module 126.

Based on the analysis, one or more structural expressions 306(s) (where “s” can be any integer from one to “S”) of the analyzed structure are derived (block 306). A variety of structural expression may be utilized to express a variety of analyzed structures. The entire MIME structure, for instance, of each of the emails 302(e) may be represented as tupled extractions from the MIME “tree” itself. The tuples may be described as “(parent, child[N], child[N+1])”. Each tuple represents an individual feature or indicator used in describing the MIME tree.

A basic example is an email message that contains a Primary/Secondary MIME type as follows:
text/html
   In the simplest form, “primary=text” and “secondary=html” may be extracted as inputs to a spam filtering process (e.g., the filter creation module 212). However, with MIME trees, this may be considered a root of a tree containing no branches beneath it.

To represent such an instance, “text/html” is treated as the root and representations of invisible branches are created beneath it. Continuing with the previous example, a single feature may be generated as follows:
(text/html, null, null).
   In a more advanced example, a simple multipart message may have a MIME structure as follows:
multipart/alternative;
text/plain; and
text/html.
   With MIME trees, following the previous tuple definition, structural expressions of features may be generated as follows:
(multipart/alternative, null, text/plain);
(multipart/alternative, text/plain, text/html); and
(multipart/alternative, text/html, null).
   Thus, these structure expressions of features of the MIME structure abstract the nature of the MIME structure and layout itself, which may be utilized to differentiate spam from non-spam.

The structural expression 306(s), for instance, may be utilized to generate one or more filters 3100), where “j” can be any integer from one to “J” (block 312). The filter creation module 212, for instance, may be executed to perform machine learning to differentiate spam from non-spam, i.e., legitimate email. For example, a spammer may generate emails more commonly in HTML than plain-text. The MIME tree feature (text/html, null, null) will represent this profile of message, and in comparison to plain text messages whose MIME tree feature is defined as (text/plain, null, null), the machine learning process may learn to associate a greater weight to the form feature as being indicative of an increased likelihood that the email is spam.

In another example, the MIME structures may identify “abnormal” structures which may be indicative of an email being spam. For example, in some cases there may be differences between email parts considered by a spam filter as opposed to email parts that an email provider and/or client rendered and displayed to a recipient of the email. With knowledge of these differences, a spammer may build a MIME structure such that “good” content for processing by a spam filter is placed in one message part while the “spam” content is placed in another part. In this case, the traditional spam filter may make a determination that the message is “good” (i.e., not spam) based on the good content alone. The “bad” (i.e., spam) content, however, may then be what is actually rendered for viewing by the recipient of the message.

In this other example, the MIME tree features help to capture this type of behavior by generalizing around “abnormal” and/or uncommon MIME structures. Continuing with the previous example, an email constructed similarly to the multipart example above may have the “children” swapped as follows:
multipart/alternative;
text/plain; and
text/html;
to
multipart/alternative;
text/html; and
text/plain.
   The “swapped” message is not compliant with Internet Engineering Task Force (IETF) Request for Comment (RFC) 2046 section 5.1.4, which states that a multipart alternative should appear in an order of increasing faithfulness to the original content. However, traditional email systems do not explicitly enforce these recommendations and render email content according to a wide variety of logic. Therefore, if the logic in the client (e.g., client 102(n)) or web-based rendering interface (e.g., communication system 108) for determining which email part to expose to a recipient differs from logic within the filter, the above scenario of “stuffing” parts with good content and other parts with spam content may be achieved. In this case, however, use of the MIME tree features captures this type of behavior and is able to help in making a determination that the email is spam, regardless of the content in either message part. Therefore, the filter 310(j) which processes a plurality of subsequent emails 314(f) (where “f” can be any integer from one to “F”) may produce results 316(f) (e.g., relative likelihood of being spam, such as a score) (block 318) that address the structure of the emails 314(f).

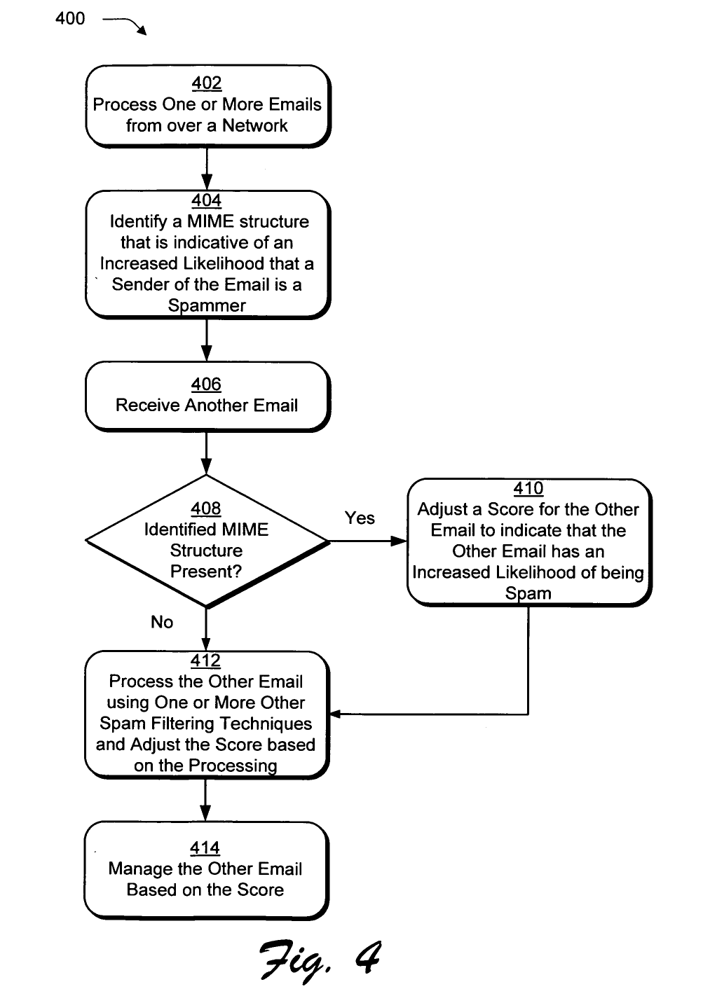

FIG. 4 depicts a procedure 400 in an exemplary implementation in which a score is computed indicating a relative likelihood that an email is spam based at least in part on a MIME structure of the email. One or more emails are processed from over a network (block 402). For example, a communication manager module 110, when executed, may process emails 122(e) for communication between the plurality of clients 102(1)-102(N). In another example, the communication module 106(1) may process emails received by the client 102(1). Thus, the processing may be performed remotely by an email provider before the email is even received by an intended recipient, upon receipt by the intended recipient, and so on. A variety of other examples are also contemplated.

During the processing, a MIME structure is identified that is indicative of an increased likelihood that a sender of the email is a spammer (block 404). For example, an “abnormal” MIME structure utilized in spam from a particular spammer may be identified, “normal” MIME structures that are more frequently utilized by spammers may be identified, and so on.

Another email is received (block 406) and a determination is made as to whether the identified MIME structure is present (decision block 408). If so (“yes” from decision block 408), a score is adjusted for the other email to indicate that the other email has an increased likelihood of being spam.

After the score is adjusted (block 410) or the identified MIME structure is not present (“no” from decision block 408), the other email is processed using one or more other spam filtering techniques and the score is adjusted based on the processing (block 412). For example, the other spam filtering techniques may examine a header of the email, a network address of the sender, content of the email, and so on to further determine whether the mail is spam and adjust the score based on the results of the processing.

The other email is then managed based on the score (block 414). For instance, the spam manager module 124 may route the other email differently (e.g., to a spam filter or inbox), block the communication of the email to the intended recipient, adjust a reputation of an indicated sender of the email, and so on. A variety of other instances are also contemplated.

### CONCLUSION

Although the invention has been described in language specific to structural features and/or methodological acts, it is to be understood that the invention defined in the appended claims is not necessarily limited to the specific features or acts as described. Rather, the specific features and acts are disclosed as exemplary forms of implementing the claimed invention.

What is claimed is:

1. A method comprising:
deriving one or more expressions that represent a multipurpose internet mail extension (MIME) structure of an email; and
determining whether the email is spam based at least in part on the derived expressions.

2. A method as described in claim 1, wherein the one or more expressions represent media types and subtypes of portions included in the email and an arrangement of the portions, one to another.

3. A method as described in claim 2, wherein at least one said portion is designated as a beginning of the arrangement and another said portion is designated as an end of the arrangement.

4. A method as described in claim 1, wherein:
the derived expression represents an ordering of relative richness of media types of corresponding portions of the email: and
the determining is based at least in part on the ordering.

5. A method as described in claim 1, wherein the deriving includes:
constructing a virtual tree that represents the MIME structure of the email; and
generating the expressions as representations of individual features used in describing the virtual tree.

6. A method as described in claim 5, wherein:
the deriving includes constructing a virtual tree that represents the MIME structure of the email using a plurality of nodes; and
the ordering makes distinct a first and last child said node of each parent said node in the virtual tree.

7. A method as described in claim 1, wherein the determining includes executing one or more filters created based on an analysis of a multipurpose internet mail extension (MIME) structure of a plurality of other email.

8. A method comprising:
analyzing a multipurpose internet mail extension (MIME) structure of each of a plurality of email; and
creating a filter, based on the analysis, to identify unsolicited commercial email.

9. A method as described in claim 8, wherein:
the analyzing includes creating one or more expressions which represent the multipurpose internet mail extension (MIME) structure of each of the plurality of email; and
the one or more expressions represent media types and subtypes of portions included in each said email and an arrangement of the portions, one to another.

10. A method as described in claim 9, wherein at least one said portion is designated as a beginning of the arrangement and another said portion is designated as an end of the arrangement.

11. A method as described in claim 9, wherein:
the derived expression represents an ordering of relative richness of media types of corresponding portions of the email: and
the creating is performed such that the filter addresses the ordering when processing email.

12. A method as described in claim 8, wherein the analyzing includes:
constructing a virtual tree that represents the MIME structure of each said email; and
generating the expressions as representations of individual features used in describing the virtual tree.

13. A method as described in claim 8, wherein:
wherein the analyzing includes constructing a virtual tree that represents the MIME structure of the email using a plurality of nodes; and
the ordering makes distinct a first and last child said node of each parent said node in the virtual tree.

14. A method as described in claim 8, wherein the creating is performed using machine learning.

15. One or more computer readable media comprising computer executable instructions that, when executed on a computer, direct the computer to process email using a filter configured to identify unsolicited commercial email based at least in part on arrangement of media types of portions of an email, one to another.

16. One or more computer-readable media as described in claim 15, wherein the arrangement of the media types of the portions of the email is derived from a multipurpose internet mail extension (MIME) structure of the email

17. One or more computer-readable media as described in claim 15, wherein the computer-executable instructions direct the computer to identify unsolicited commercial email by:
deriving one or more expressions that represent a multipurpose internet mail extension (MIME) structure the email; and
compute a relative likelihood that the email is unsolicited commercial email based at least in part on the derived expressions.

18. One or more computer-readable media as described in claim 17, wherein the one or more expressions represent media types and subtypes of portions included in the email and an arrangement of the portions, one to another.

19. One or more computer-readable media as described in claim 18, wherein at least one said portion is designated as a beginning of the arrangement and another said portion is designated as an end of the arrangement.

20. One or more computer-readable media as described in claim 18, wherein the arrangement represents an ordering of relative richness of media types of corresponding portions of the email.
